(19) United States
(12) Patent Application Publication
(10) Pub. No.: US 2008/0101617 A1
(43) Pub. Date: May 1, 2008

(54) Two-Channel to Three-Channel Audio Converter

(76) Inventor: Cheng-Hung Huang, Taipei County (TW)

Correspondence Address: Venable LLP;Raymond J. Ho, 575 7th Street NW, Washington, DC, 20004-1601, US

(21) Appl. No.: 11/551,714

(22) Filed: Oct. 21, 2006

(51) Int. Cl. H04R 5/00

(52) U.S. Cl. 381/18; 381/27; 381/99

(57) ABSTRACT

A two-channel to three-channel audio converter that separates the lower frequency output signals from one of the left channel and the right channel is provided. Respective filters are used to separate the lower frequency outputs and the middle to high frequency outputs from the audio output signals of the computer device. An equalizer balances the powers of the left channel and the right channel outputs, so that the mismatches in the resistance may be avoided.

### FIELD OF THE INVENTION

The present invention relates to a controller for audio amplifier and its circuit design, especially to a circuit device to convert the two-channel audio outputs into three-channel audio outputs.

### BACKGROUND OF THE INVENTION

The “Class-D” audio amplifier is a highly efficient output device that uses the circuit switching technology to enhance the working efficiency of the audio power amplifier. The high efficiency of the Class-D audio amplifier is because the CMOS works under fully ONs and fully OFFs. The high efficiency aid low power consumption are the features of the D-class amplifier that make the devices using the D-class amplifier suited in the USB interface portable applications, such as in the notebook computer, the MP3 player etc.

In the current 3-channel applications, a USB portable device separates the lower frequency outputs from the left channel and the right channel signals simultaneously and provides the lower frequency outputs to the woofer. Such a device shall be provided with two signal separation devices and one output controller for the woofer. The cost of the device is thus made relatively high. As it is necessary to supply powers to the signal separation devices and the output controller for the woofer, relative power consumptions are necessary. The power consumption is the most important consideration in the design of the USB portable devices. A device with higher power consumptions may not be used in the USB portable devices.

### OBJECTIVES OF THE INVENTION

The objective of this invention is to provide a simplified two-channel to three-channel audio converter.

Another objective of this invention is to provide a low-cost two-channel to three-channel audio converter.

Another objective of this invention is to provide a two-channel to three-channel audio converter with lower power consumption.

Another objective of this invention is to provide a two-channel to three-channel audio converter that effectively separate the lower frequency output signals.

### SUMMARY OF THE INVENTION

According to this invention, a two-channel to three-channel audio converter that separates the lower frequency output signals from one of the left channel and the right channel is provided. Respective filters are used to separate the lower frequency outputs and the middle to high frequency outputs from the audio output signals of the computer device. An equalizer balances the powers of the left channel and the right channel outputs, so that the mismatches in the resistance may be avoided.

The two-channel to three-channel audio converter of this invention comprises:

a computer interface controller to communicate with a computer and to conduct control functions through a computer interface;

a decoder to decode audio signals from said computer to obtain audio information contained in said audio signals;

a left channel controller to obtain said decoded audio information and to provide said audio information to a left channel speaker;

a right channel controller to obtain said decoded audio information and to provide said audio information to a right channel speaker;

a first filter to obtain from output audio information of said left channel controller audio information of a first frequency band, as left channel outputs;

a second filter to obtain from output audio information of said right channel controller audio information of a second frequency band, as right channel outputs;

a third filter to obtain from output audio information of said left channel controller or said right channel controller audio information of a third frequency band, as lower frequency outputs; and

an equalizer, connecting said left channel controller and said right channel controller to equalize powers of outputs of said left channel and said right channel.

In the present invention, the filtering schematics of the third filter are different from that of the first and the second filters. In some embodiments, the third filter is a coil type inductor, whereby the high frequency output power of the third filter is regulated by its inductance values. In another embodiment of this invention, the first and the second filters are capacitors, in particular the electrolytic capacitor, whereby the audio output powers of the undesired frequency bands are filtered out.

These and other objectives and advantages of this invention may be clearly understood from the detailed description by referring to the following drawings.

### BRIEF DESCRIPTION OF THE DRAWINGS

FIG. 1 illustrates the block diagram of a conventional two-channel to three-channel audio converter.

FIG. 2 illustrates the block diagram of the two-channel to three-channel audio converter of this invention.

### DETAILED DESCRIPTION OF THE INVENTION

The two-channel to three-channel audio converter of this invention will be illustrated and described in the followings. Before the description of the two-channel to three-channel audio converter of this invention, the conventional two-channel to three-channel audio converter will be described first.

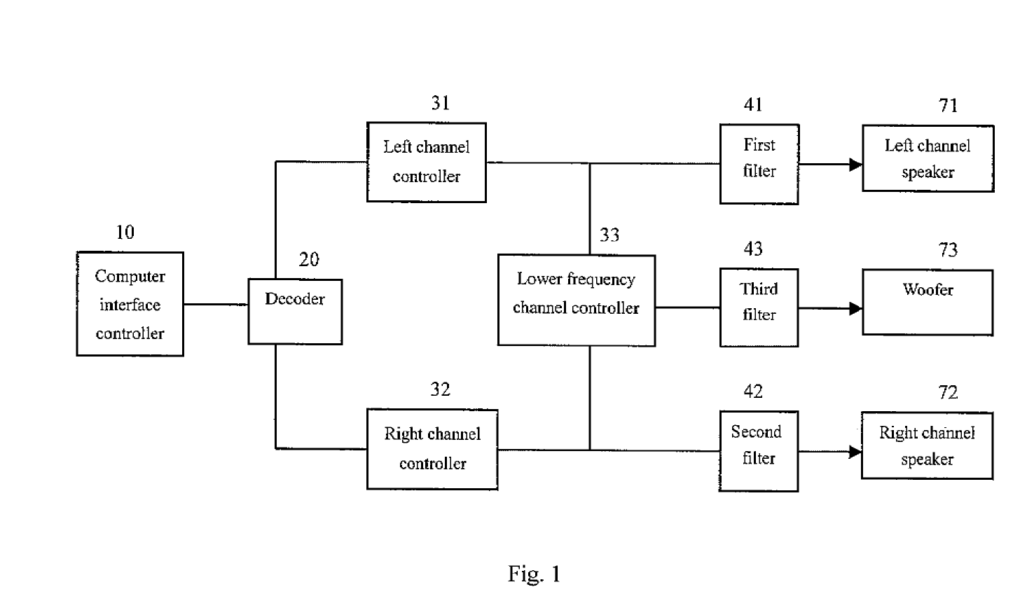

FIG. 1 illustrates the block diagram of a conventional two-channel to three-channel audio converter. As shown in this figure, the conventional two-channel to three-channel audio converter comprises:

a computer interface controller 10 to communicate with a computer device 11 and to conduct control functions through a computer interface (not shown);

a decoder 20 to decode audio signals from said computer 11 to obtain audio information contained in said audio signals;

a left channel controller 31 to obtain output audio information of said decoder 20 and to provide said audio information to a left channel speaker 71;

a right channel controller 32 to obtain output audio information of said decoder 20 and to provide said audio information to a right channel speaker 72;

a lower frequency channel controller 33 to obtain output audio information of said left channel controller 31 and said right channel controller 32 and to provide said audio information to a woofer 73;

a first filter 41 to obtain from output audio information of said left channel controller 31 audio information of a first frequency band, as left channel outputs;

a second filter 42 to obtain from output audio information of said right channel controller 32 audio information of a second frequency band, as right channel outputs; and

a third filter 43 to obtain from output audio information of said lower frequency channel controller 33 audio information of a third frequency band, as lower frequency outputs.

In the circuit of FIG. 1, the lower frequency channel controller 33 is used to separate the lower frequency elements in the outputs of the left channel controller 31 and the right channel controller 32, as the lower frequency outputs. As a result, the cost of the device is increased and additional power consumptions are necessary. In addition, the first, second and third filters 41, 42 and 43 function to filter out noises, not to separate the frequency bands of the output audio signals. They play no role in the separation of the output frequency bands. Generally speaking the filters 41, 42 and 43 are small size inductors and capacitors. They can only depress the surges and to filter out noises.

The present invention provides a novel structure for the two-channel to three-channel audio converter. The two-channel to three-channel audio converter of this invention separates the lower frequency elements of the audio information from the outputs of the left channel controller or the right channel controller directly. Therefore, the lower frequency controller is no longer necessary. In the present invention, the working principle of the third filter is different from that of the first and the second filters, so to enhance the effects of the separation of the frequency bands.

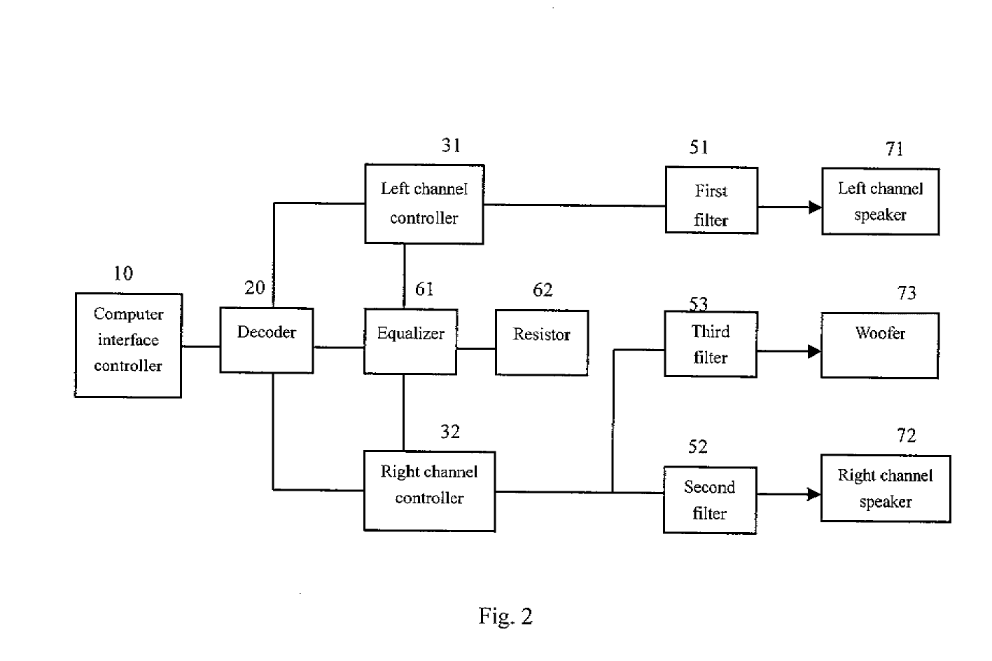

FIG. 2 illustrates the block diagram of the two-channel to three-channel audio converter of this invention. The components in FIG. 2 which are the same as that in FIG. 1 are labeled with the same numbers. As shown in this figure, the two-channel to three-channel audio converter of this invention comprises:

a computer interface controller 10 to communicate with a computer 11 and to conduct control functions through a computer interface (not shown);

a decoder 20 to decode audio signals from said computer 11 to obtain audio information contained in said audio signals;

a left channel controller 31 to obtain output audio information of said decoder 20 and to provide said audio information to a left channel speaker 71;

a right channel controller 32 to obtain output audio information of said decoder 20 and to provide said audio information to a right channel speaker 72;

a first filter 51 to obtain from the output audio information of said left channel controller 31 audio information of a first frequency band, as left channel outputs;

a second filter 52 to obtain from the output audio information of said right channel controller 32 audio information of a second frequency band, as right channel outputs;

a third filter 53 to obtain from the output audio information of said left channel controller 51 or said right channel controller 52 audio information of a third frequency band, as lower frequency outputs to a woofer 73; and

an equalizer 61, connecting said left channel controller 31 and said right channel controller 32 to equalize powers of outputs of said left channel and said right channel.

In the above components, the computer interface may be the USB interface, since it is the most popular computer communication interface in the market. Of course, other wired communication interfaces, such as the PCMCIA interface, the CardBus interface, the IEEE 1394 interface, the PCI interface etc., and wireless interfaces, such as the infrared, the Bluetooth, the radio etc. interfaces may also be applied in the present invention. As the control and the circuit designs of the interface controller 10, it may be any of the known technologies or their derivations. Detailed descriptions thereof are thus omitted.

The decoder 20 may be any commercially available audio decoder. Generally speaking, it is possible to use a D/A converter to decode the output audio signals of the computer 11. In the left channel controller 31 and the right channel controller 32, the same amplifier may be used. In the embodiments of the present invention, the “Class D” audio amplifiers, especially the ones with the CMOS H-bridge outputs, may be used as these controllers 31, 32. The high efficiency and the low power consumption of the Class D audio amplifiers may thus be enjoyed. It is also possible to use other types of amplifiers in this invention. Since they are known to those skilled in the art, detailed descriptions thereof are thus omitted.

It is also possible to use any known technology in the first filter 51 and the second filter 52, the electrolytic capacitor is recommended for its good band-separation effects. In other words, the smaller the capacitance of the electrolytic capacitor is, the slower the frequency responses of the output audio signals in the lower frequency band are. For example, if the capacitance of the electrolytic capacitor is 22 μF, the output audio signals below 1.5 KHz would be blocked. When the capacitance of the electrolytic capacitor is 33 μF the output audio signals below 700 Hz would be blocked. Therefore, it is possible to limit the output of the lower frequency signals from the left channel and the right channel by the values of the capacitance of the electrolytic capacitors. The audio signals of the left channel and the right channel in the desired frequency bands may be clearly abstracted by adjusting the capacitance of the electrolytic capacitor.

In the present invention the third filter 53 uses different working principles other than that of the first and the second filters 51, 52. In the application of this invention, the third filter 53 may be an inductor. In the embodiments of this invention, the examples of the third filter 53 include a filter comprising coils or inductor. It is already known from the experiences that the larger the inductance of the coil or the inductor is, the narrower the scope of the frequency responses of the output audio signals in the higher frequencies is. For example, if the inductance of a coiled inductor is 100 μH, the output audio signals over 6 KHz would be blocked. If the inductance is 220 μH, the effective output audio signals will be limited to below 3 KHz. Therefore, the lower frequency elements of the output audio signals may be separated from the left channel or the right channel.

Generally speaking, it is possible to set the output frequency band of the left channel to above 1.5 KHz and that of the right channel to above 1.5 KHz as well. As a result, the output frequency band of the lower frequency channel would be set at below 1.5 KHz. In this ease, the capacitance of the electrolytic capacitors in the first filter 51 and the second filter 52 may be about 22 μF and the inductance of the coiled inductor in the third filter 53 may be about 220 μH. Of course, it is possible to modify the above settings according to the needs in the application. One important feature of this invention, however, is that the third filter of this invention provides the “plug-and-play” function, enabling the user to connect the present invention to an internal woofer at any time and in any place.

In the above design, the mismatch of the two speakers connected in parallel in one output will not take place, if the three filters 51, 52 and 53 and the high frequency speakers and the woofer are effectively arranged. However, it is difficult to make correct arrangements. In the present invention, in order to avoid the mismatch of the left channel outputs and the right channel outputs, an equalizer 61 is used. The equalizer 62 does not only balance the outputs of the two channels but also make it possible for the user to use any type and model of speakers in connection with the present invention. The resistor 62 is used to set the parameters of the equalizer 61. The settings of the equalizer 61 is determined by the voltage divided by the two channels. It is possible to adjust the resistance of the resistor 62 to directly vary the output power of the left channel and the right channel, so to achieve the balance. The structure of the equalizer 61 and the resistor 62 is known to those skilled in the art. Detailed descriptions thereof are thus omitted.

In the present invention the audio outputs of the speakers 71,72 and the woofer 73 are divided by their frequencies. Therefore, the multiple power consumption due to two speakers sharing one single output will not happen. In order to solve the problem of the mismatch in resistance due to the parallel connection of the two speakers, the present invention uses the equalizer 61 to balance the power of the audio outputs of the two channels. A resistor 62 is then used to drive the equalizer 61 to control the balance in the outputs of the two channels.

In addition, the present invention uses different filters to separate the higher frequency bands and the lower frequency bands. The separated outputs are effectively provided to the speakers 71, 72 and the woofer 73. As a result, it is possible to drive the speakers 71, 72 and the woofer 73 simultaneously with only one output device. The additional output device to drive the woofer 73 is thus omitted.

In the embodiments of this invention, an automated switch or a manual switch may be added to control the operations of the third channel. In other words, it is possible to set the lower frequency channel in the working mode or in the sleep mode. When the lower frequency channel is under the automated switch mode, it will start to work after the connector of a woofer is connected. The equalizer 61 may automatically balance the outputs of the left channel and the right channel according to the working mode of the third channel. The imbalance of the left channel and the right channel due to the variation of the working mode of the third channel may be effectively avoided.

As the present invention has been shown and described with reference to preferred embodiments thereof, those skilled in the art will recognize that the above and other changes may be made therein without departing from the spirit and scope of the invention.

What is claimed is:

1. A two-channel to three-channel audio converter, comprising:
a computer interface controller to communicate with a computer and to conduct control functions through a computer interface;
a decoder to decode audio signals from said computer to obtain audio information contained in said audio signals;
a left channel controller to obtain output audio information of said decoder and to provide said audio information to a left channel speaker;
a right channel controller to obtain output audio information of said decoder and to provide said audio information to a right channel speaker;
a first filter to obtain from the output audio information of said left channel controller audio information of a first frequency band, as left channel outputs;
a second filter to obtain from the output audio information of said right channel controller audio information of a second frequency band, as right channel outputs;
a third filter to obtain from the output audio information of said left channel controller or said right channel controller audio information of a third frequency band, as lower frequency outputs; and
an equalizer, connecting said left channel controller and said right channel controller to equalize powers of outputs of said left channel and said right channel.

2. The two-channel to three-channel audio converter according to claim 1, wherein said third filter uses different filtering schematics other than that of said first and said second filters.

3. The two-channel to three-channel audio converter according to claim 2, wherein said third filter is a coil type inductor.

4. The two-channel to three-channel audio converter according to claim 2, wherein said first and said second filters are capacitors.

5. The two-channel to three-channel audio converter according to claim 4, wherein said first and said second filters are electrolytic capacitors.

6. The two-channel to three-channel audio converter according to claim 1, wherein said computer interface is the USB interface.

7. The two-channel to three-channel audio converter according to claim 1, wherein said left channel controller and said right channel controller comprise “Class D” audio amplifiers.

8. The two-channel to three-channel audio converter according to claim 7, wherein said “Class D” audio amplifiers comprise CMOS H-bridge outputs.

9. The two-channel to three-channel audio converter according to claim 1, further comprising a switch to control operations of said third channel.
